(19) United States
(12) Patent Application Publication
(10) Pub. No.: US 2013/0334188 A1
(43) Pub. Date: Dec. 19, 2013

(54) POWER ROUTING FOR WELDING SUITE

(71) Applicant: LINCOLN GLOBAL, INC., CITY OF INDUSTRY, CA (US)

(72) Inventors: EDWARD A. ENYEDY, EASTLAKE, OH (US); MARK DAVID MCDOWELL, EL DORADO HILLS, CA (US)

(73) Assignee: LINCOLN GLOBAL, INC., CITY OF INDUSTRY, CA (US)

(21) Appl. No.: 13/972,423

(22) Filed: Aug. 21, 2013

Related U.S. Application Data
(63) Continuation-in-part of application No. 12/975,206, filed on Dec. 21, 2010.
(60) Provisional application No. 61/831,934, filed on Jun. 6, 2013.

(51) Int. Cl. B23K 9/095

(52) U.S. Cl. CPC B23K 9/095
USPC 219/130.21

(57) ABSTRACT

The invention described herein generally pertains to an apparatus for a welding operation having two or more welding tools and a switching device which directs the current to the appropriate welding device for a welding operation. One or more switch devices having two or more settings can be employed to control which device or devices receive current. Moreover, varying remote control techniques can be utilized to control a welding power source or other operatively coupled devices. Powered devices other than welding tools may be used with the switch in embodiments.

### CROSS-REFERENCE TO RELATED APPLICATIONS

The present application claims the benefit of U.S. Provisional Patent Application 61/831,934, entitled POWER ROUTING FOR WELDING SUITE filed on Jun. 6, 2013, and is additionally a continuation-in-part of U.S. patent application Ser. No. 12/975,206, entitled WIRE FEEDER WITH ELECTRODE POWER ROUTING filed on May 7, 2007, the entireties of which are incorporated herein by reference.

### TECHNICAL FIELD

Devices, systems, and methods consistent with the invention relate to a method and apparatus for routing power to welding electrodes in a wire feeder.

### BACKGROUND OF THE INVENTION

Wire feeders are known in the welding industry. Dual wire feeders are wire feeders which employ two sets of wire drive mechanisms which are separately coupled to two different welding guns and two different sources of welding consumables. Typically a common control box controls the wire drive mechanisms and connects to the welding power source, which supplies a welding current. Dual wire feeders are typically used in environments where two different types of welding electrodes are frequently needed. By using a dual wire feeder, the cost of a separate power source is avoided, and the delay from change over from one welding process to another is reduced. As an example, steel metal-inert-gas (MIG) wire may be mounted on one side of the dual feeder and the other side has a flux-cored wire mounted on it for different welding operations.

Other tools utilizing a common welding power source can also be employed in conjunction with wire feeder devices. For example, gouging torches can be used in the welding industry. Gouging torches can include welding devices utilizing electrodes to remove or cut portions of a work piece. Gouging torches can utilize techniques such as carbon-arc gouging, plasma gouging, and oxyfuel gouging. It is frequently beneficial to have a gouging torch collocated with a wire feeder, and/or coupled to a common welding power source. However, the gouging torch frequently connects directly to the welding power source, requiring control at the power source rather than at the work piece.

Thus, a common problem with existing dual wire feeders and associated tools such as gouging torches is that all electrodes share a common voltage such that both wire drives, and subsequently the respective welding guns associated with those drives, are electrically hot at the same time. Further, it may be expensive or impractical to attempt to retrofit existing wire feeders, associated tools, and/or welding power sources to overcome these deficiencies.

### SUMMARY OF THE INVENTION

In accordance with the present invention, there is provided a system for controlling an electrical current to a first welding tool and a second welding tool. The system may include a switch device operatively coupled to a welding power supply and the first welding tool and the second welding tool that controls the electrical current from the welding power supply to the at least one welding tool. There may also be provided a control circuit communicatively coupled with the switch device which automatically controls the switching of the switch device between at least a first setting and a second setting. When the switch device is in the first setting, a first current is directed to the first welding tool such that the second welding tool electrically isolated from the first current. Further, when the switch device is in the second setting, a second current is directed to the second welding tool such that the first welding tool is electrically isolated from the second current.

In accordance with the present invention, there is provided a power routing system. The power routing system may comprise a first welding tool powered according to a first parameter set through a wire feeder, the wire feeder is coupled with a welding power supply and a second welding tool powered according to a second parameter set, the second welding tool is coupled with the welding power supply. The power routing system may also include a switch device configured to complete a circuit between at least the welding power supply and the first and second welding tools and a control circuitry of the switch device that controls switching between at least a first setting and a second setting. When the switch device is in the first setting, a first current is directed to the first welding tool such that the second welding tool is electrically isolated from the first current. When the switch device is in the second setting, a second current is directed to the second welding tool such that the first welding tool is electrically isolated from the second current.

Further in accordance with the present invention, there is provided a method of routing current to a plurality of welding tools. The method may include the aspect of providing a switch device for completing a circuit between a welding power supply and at least one of a first welding tool and a second welding tool. The method may include receiving a signal related to at least one of the first welding tool and the second welding tool. The method may further comprise providing a current to at least one of the first welding tool and the second welding tool based on a setting of the switch device and modifying a parameter of the welding power supply based on the setting of the switch device.

These and other objects of this invention will be evident when viewed in light of the drawings, detailed description, and appended claims.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a first perspective view of a wire feeder system;

FIG. 2 illustrates a diagrammatical schematic representation of a wire feeder system and positionable switch;

FIG. 3 illustrates a diagrammatical schematic representation of another wire feeder system in which control circuitry determines at least the proper positioning of the switch;

FIG. 4 illustrates a diagrammatical schematic representation of yet another wire feeder system illustrating an at least partially wireless configuration;

FIG. 5 illustrates a diagrammatical schematic representation of still yet another wire feeder system in which each welding gun has an activation switch mechanism;

FIGS. 6A and 6B illustrate diagrammatical schematic representations of a wire feeder and gouging torch;

FIG. 7 illustrates a diagrammatical schematic representation of a switch device used in conjunction with a welding suite;

FIG. 8 illustrates a diagrammatical schematic representation of a switch device used in conjunction with a welding suite including wireless communication; and

FIG. 9 illustrates a diagrammatical schematic representation of a switch device used in conjunction with a welding suite where at least one device of the welding suite includes additional control circuitry.

### DETAILED DESCRIPTION OF THE INVENTION

Exemplary embodiments of the invention will now be described below by reference to the attached FIGS. The described exemplary embodiments are intended to assist the understanding of the invention, and are not intended to limit the scope of the invention in any way. Like reference numerals refer to like elements throughout.

As used herein, a welding tool may be a tool used in conjunction with welding or similar operations. For example, welding tools may include one or more wire feeder welders (guns), a wire feeder to which the one or more wire feeder welders are attached, a gouging torch, plasma cutter, and other devices that utilize a current provided by a welding power source. While embodiments herein are generally directed toward welding tools, and particularly welding tools that maintain an electric arc with a work piece, such aspects are not intended to restrict the systems and methods disclosed herein from practice with other powered devices. For example, power routing devices and associated controls can manage power for and provide power to non-welding tools such as grinders, saws, drills, et cetera, without departing from the scope or spirit of the innovation.

Aspects herein can be directed toward switching between different types of welding tools. Dissimilar welding tools are those that have different requirements to utilize. For example, dissimilar welding tools may require or permit the use of different power source parameters, such as different electrical currents. Dissimilar welding tools may perform dissimilar functions. An example of this can include a first welding tool may add metal to a workpiece (e.g., shielded metal arc welding), while a dissimilar welding tool removes metal from the workpiece (e.g., arc gouging). Another example can describe a welding tool that joins two work pieces, and one that cuts or separates one into two. Finally, dissimilar welding tools can also have different physical requirements, such as different wire specifications (e.g., materials, diameter), different handling or control means, or different geometries and components.

As alluded, dissimilar welding tools can perform dissimilar welding processes. While several forms of dissimilarity are identified, one form of dissimilarity that can be managed through control techniques herein is the parameters at a welding power supply. As used herein, a “dissimilar welding process”, “dissimilar welding operation”, or other aspects described as “dissimilar” are those that employ a change to the parameters of the welding power supply unit. This can include one or more of a change in the magnitude or polarity of the current, voltage, and frequency. While control can be focused in the power supply, other dissimilar processes can be controlled according to control of flow from a gas source or the rate at which a specific type of consumable electrode is fed.

Control related to dissimilar welding tools, dissimilar processes, or other aspects herein can be performed using a device at least partially outside welding components or tools. For example, a peripheral switch box can be attached to or placed in communication with one or more components of a welding system (e.g., power supply, welder, torches, other powered tools) to facilitate control as described herein. The peripheral switch box can be a separate intermediary device from the other components of the welding system, which can be connected or otherwise operatively coupled with the welding system. The peripheral switch box can be acquired separately from the components of the welding system (e.g., as a later-purchased add-on or upgrade). In embodiments, a peripheral switch box can utilize wired connections (e.g., cable between power supply and welder, cable between welder and welding tool) and be connected between two or more components to manage control of one or more connected, downstream, or upstream components. In some embodiments, a peripheral switch box can utilize wireless communication (e.g., control signal to power supply) to manage control of one or more connected, downstream, or upstream components.

As used herein, an integrated power cable is a power cable capable of carrying power for at least two dissimilar welding processes. When a power supply changes, for example, current or polarity to provide appropriate power for a welding operation or a gouging operation, the power can be transmitted through a first connection from the power supply to a wire feeder and second connection from the power supply to a gouging torch. An integrated power cable is capable of performing the combined function of both the first connection and the second connection, and provides both connections through the same portion of conductive material (e.g., inside of the cable). An integrated power cable is distinct from a bundle or plurality of cables or lines that are grouped, bound, mutually insulated, run through a common conduit, and so forth, as such configurations ultimately still have the first connection and second connection established by different cables, even if these cables or lines are clustered in a “super-cable.”

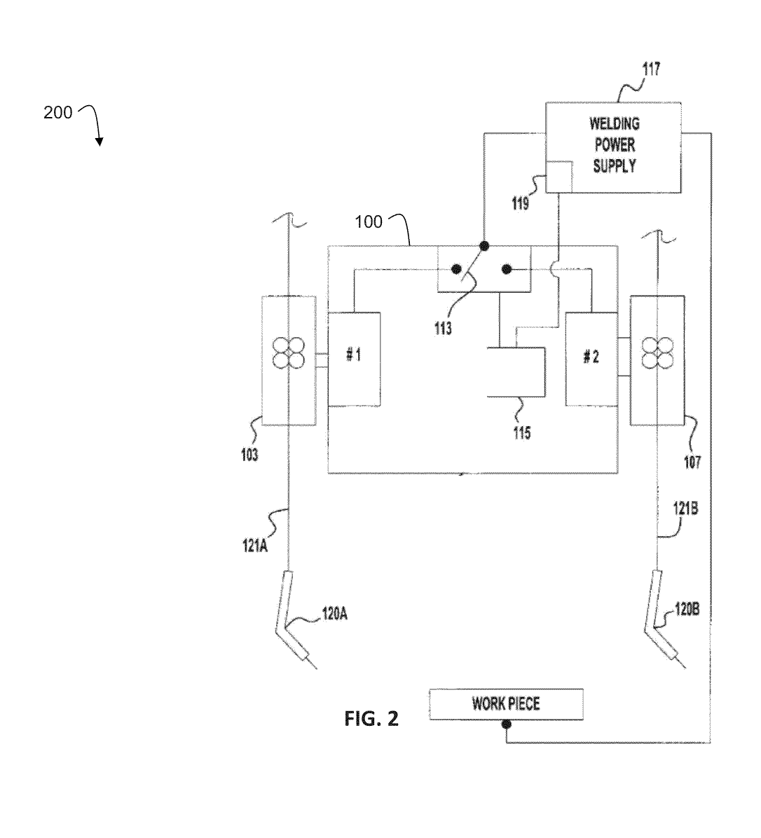

As used herein, the terms “downstream” and “upstream” are used flexibly to refer to electrical elements further from or nearer to a power source. For example, in FIG. 2, wire feeder 100 is downstream of welding power source 117, and welding guns 120A and 120B are downstream of wire feeder 100. The work piece is the furthest downstream element, even if the circuit is closed through a connection between the work piece and welding power source 117.

As used herein, a “logic” can be an aspect implemented as electronic hardware or software. For example, a “logic component” can be a hardware, software, or combination thereof that provides function or control.

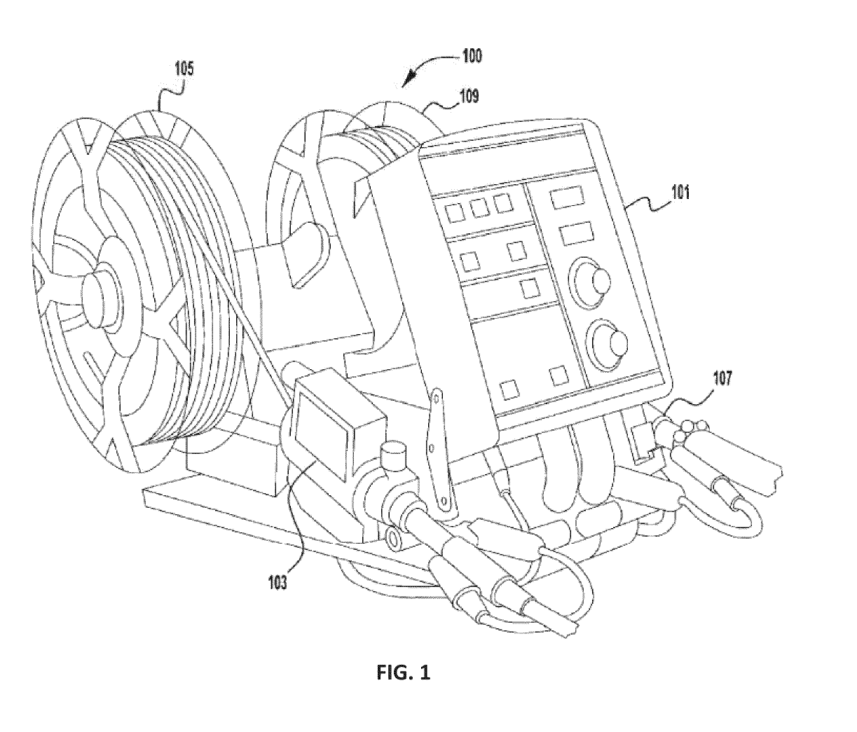

Turning now to FIG. 1, an exemplary embodiment of wire feeder 100 in accordance with an exemplary embodiment of the present invention is shown. Wire feeder 100 depicted is a dual-type wire feeder having two separate wire drive systems 103 and 107, control panel 101 and two separate wire spool mounting structures 105 and 109 (depicted with wire spools thereon). Control panel 101 contains various controls to operate wire feeder 100. Further, the general structure and operation of wire drive systems 103 and 107 can be similar to existing wire drive systems.

Although a dual wire feeder configuration is shown as an exemplary embodiment in FIG. 1 (as well as other figures) the present invention is not limited to the use of only two wire drive systems. Specifically, because of the attributes of the present invention, it is contemplated that a wire feeder system in accordance with the present invention can have three or more wire drive systems which can be set up with different welding electrodes and/or for different welding operations. Because the structure and operation of such a system is similar to that of a dual system described below, it is unnecessary to discuss in detail the specific operation of such a system. However, the following discussion related to a dual feeder embodiment is equally applicable to embodiments having three or more wire drive systems.

Turning now to FIGS. 1 and 2, during operation wire feeder 100 obtains its operational power from any one of welding power source 117 (which are well known in the art to have auxiliary power outlets), utility power or generator power. This power is employed to operate wire drive systems 103 and 107, which typically comprise at least one motor and drive rollers. Because wire drive systems of the type used on dual or single wire feeder systems are generally known, their specific construction and operation will not be discussed in detail herein. However, generally a wire drive system uses at least one motor and drive rollers to pull a welding electrode from an electrode source, such as spools (as shown in FIG. 1) and direct that electrode to welding device/gun 120A and 120B to perform a welding operation on a work piece. Although the term welding device or gun is used throughout this application, this is intended to include all types of welding torches.

It is noted that although welding devices 120A and 120B are depicted as semi-automatic welding guns, the present invention is not limited to this embodiment. Specifically, any known welding devices and/or torches, including those used in robotic or automatic welding operations, can be coupled to the wire feeder.

Wire drive systems 103 and 107 and control panel 101 allow for the wire feed speed and/or roller configuration to be adjusted by a user so that the appropriate welding electrode and weld parameters were used during a welding operation. If a user wanted to perform a first welding operation the user would use welding gun 120A associated with first welding electrode 121A and first wire drive device 103 and then when the user wants to perform a second welding operation the user would use second welding gun 120B associated with second electrode 121B and wire drive system 107. To reduce costs, wire feeder 100 is electrically coupled to single welding power source 117 which is capable of providing welding power for different types of welding operations. Thus, for a first welding operation, which requires the use of electrode 121A associated with first wire drive device 103, welding power source 117 provides a first welding current or waveform to wire feeder 100. This welding power/current is directed to first wire drive device 103 and ultimately to first welding gun 120A and into first electrode 121A for welding. Then, for a second welding operation, typically requiring a different type of welding electrode, power supply 117 provides a second welding current/waveform to wire feeder 100 which is directed to second wire drive device 107 and ultimately second welding gun 120B and second electrode 121B for a second type of welding operation.

With prior dual wire feeder systems the welding current/waveform from welding power source 117 was directed to both wire drive devices 103/107 at the same time. Thus, if the welding current was intended for the first welding operation (using first wire drive device 103, welding gun 120A and electrode 121A) it was also equally directed to second wire drive device 107 and its associated electronics. Thus, even though only one welding operation can occur at a time, both wire drive devices 103/107 were electrically “hot.” That is, both sides of wire feeder 100 were receiving the same welding current, resulting in both welding guns 120A and 120B having this welding current and being “hot”. That is, in these prior systems both wire drive devices 103/107 are electrically tied to a common electrode voltage. This causes safety and other operational problems.

In one or more aspects of the invention illustrated in at least FIG. 2, wire feeder 100 contains switch 113 which directs the welding current/waveform from power supply 117 to the appropriate wire drive device and welding gun, while electrically isolating the remaining unused wire drive devices. For example, if the first welding operation is to be performed switch 113 directs the welding power from power supply 117 to first wire drive device 103 and gun 120A and preventing the welding power from going to second wire drive device 107 and welding gun 120B. This ensures that second gun 120B is not electrically hot and does not pose a safety hazard. Correspondingly, when the second welding operation is to be performed switch 113 is activated to provide the welding power to second wire drive device 107 and welding gun 120B resulting in the isolation of first wire drive device 103.

In another aspect of the invention, switch 113 has a “neutral” position in which switch 113 is open to each of wire drive devices 103/107. In such an embodiment the neutral positioning of switch 113 increases the safety of wire feeder 100 by preventing inadvertent injury if the power supply is left on or is malfunctioning in some way.

In various aspects of the present invention, the welding current/waveform may be directed through the switch directly to welding devices/guns 120A/120B or through wire drive devices 103/107. The present invention is not specifically limited in this regard. Specifically, it is contemplated that it is not necessary to deliver the welding current/waveform through either of wire drive devices 103/107 to their respective welding devices 120A/120B, respectively. Thus, in an embodiment of the present invention, the delivery of the welding current/waveform to the welding devices via switch 113 is not necessarily through wire drive mechanisms 103/107, so long as the switch electrically isolates welding device/gun 120A/120B when not in use.

In embodiments of the present invention, switch 113 can be of any known type, including but not limited to a contactor type switch, a motor drive switch, a silicon type switch (such as an IGBT), or any other type of appropriate electrical switches.

In at least one aspect, switch 113 can be of a manual switch type in which the user of wire feeder 100 manually selects the appropriate switch position for the appropriate welding operation to be performed. In such an embodiment the manual control of the switch can be found on control panel 101 of wire feeder 100.

In another exemplary embodiment of the present invention, switch 113 is controlled from welding power source 117. For example, as shown in FIG. 2, switch 113 is coupled to control circuitry 115, which is coupled to power supply 117. Power supply 117 contains control circuitry 119 which allows a user to control switch 113 from the power supply. This is advantageous in situations where power supply 117 is located closer to the user than wire feeder 100. In such an embodiment, the user can control switch 113 via control circuitry 119 on power supply 117. In one embodiment, a manual switch is located on power supply 117 which, through control circuitry 119, controls switch 113 on wire feeder 100.

In yet a further embodiment of the present invention, control circuitry 119 of the power supply automatically activates switch 113 in wire feeder 100 based on the welding operation or welding parameters selected on power supply 117. Specifically, control circuitry 119 in power supply 117 is configured such that when the operator selects a specific welding operation or parameter on power supply 117 control circuitry 119 automatically determines the proper positioning of switch 113 and causes control circuitry 115 in the wire feeder to properly position switch 113. This embodiment helps to eliminate issues associated with improper manual switching. For example, welding power source 117 can have preprogrammed welding programs for specific welding operations, which require specific welding electrodes and wire feed speeds. As the specific welding program or operation is selected at power supply 117, control circuitry 119 determines which of wire drive devices 103/107 in wire feeder 100 should be active and switch 113 is positioned accordingly. In an alternative embodiment, it is control circuitry 115 in wire feeder 100 which makes the determination.

In further aspects of the invention, the positioning of the switch is based on a selection of the electrode to be used during the welding operation. For example, it is contemplated that either one of, or both, power supply 117 and wire feeder 100 have, respectively, input controls for an operator to input or select a welding electrode type (for example, MIG, FCAW, etc.) and control circuitry 119/115 determines and controls the appropriate positioning of switch 113 so that the desired electrode is employed. In other exemplary embodiments, other welding parameters which can be set at power supply 117 are monitored and used to control the positioning of switch 113. For example, if a user selects a pulse welding operation, or a surface tension transfer type welding operation, or a standard MIG welding operation, control circuitry 115 and/or 119 recognizes this selection and determines the appropriate positioning of switch 113 to select the proper electrode and wire driving device for that welding operation. The present invention is not limited to which parameters are employed by control circuitry 115/119 to determine the appropriate switch positioning.

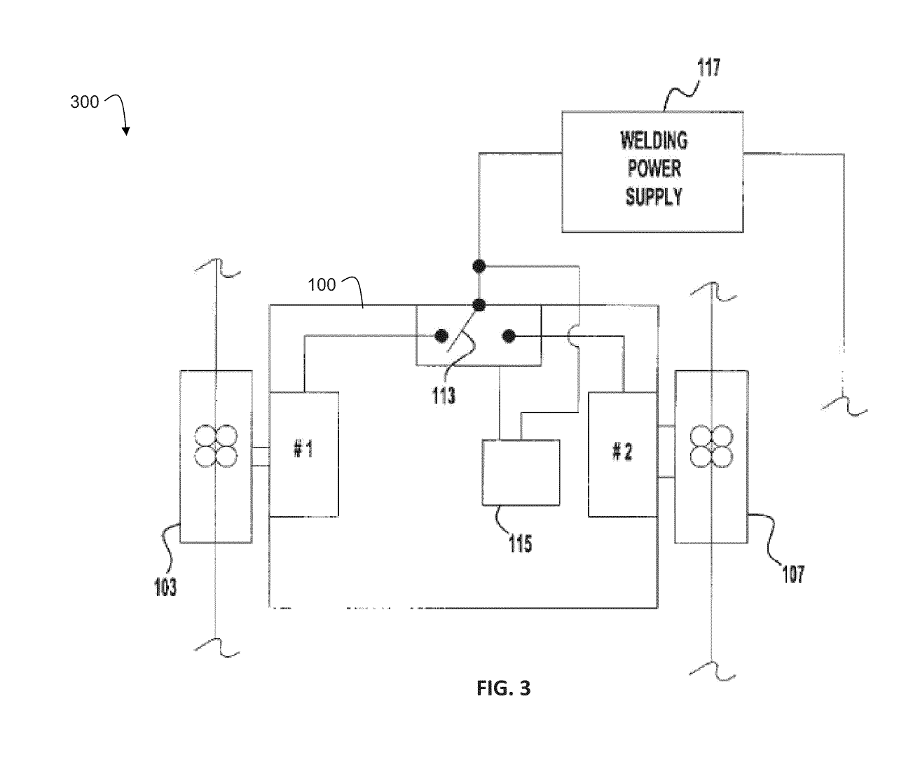

Another exemplary embodiment of the present invention is shown in FIG. 3. In this embodiment, control circuitry 115 of the wire feeder monitors/detects the welding current/waveform and, based on this detection, determines the appropriate positioning of switch 113 so as to direct the welding current to appropriate wire drive device 103/107. In this embodiment, control circuitry 115 (which may include a CPU, memory device, and other control circuitry) detects the welding current or welding waveform being sent from power supply 117 to wire feeder 100. Based on parameters from the welding signal (which can be current, voltage, pulse frequency, etc.) control circuitry 115 determines the appropriate switch position. That is, which of wire drive devices 103/107 are to receive the welding signal.

In further aspects, the control circuitry of wire feeder 100 and/or welding power source 117 uses characteristics of the welding current and/or waveform to confirm if switch 113 is positioned appropriately, and if the switch is not positioned properly, will not permit the welding operation to begin. For example, in an embodiment with a manual or automatic switching mechanism, control circuitry 115 of wire feeder 100 and/or control circuitry 119 of power supply 117 monitors/detects a weld parameter set at power supply 117 or a parameter in the welding current/signal from power supply 117 and determines an appropriate positioning of switch 113 which corresponds with the monitored or detected parameter. The wire feeder control circuitry 115 and/or 119 then detects the positioning of switch 113 and compares the detected positioning of switch 113 to the actual positioning of switch 113. If the positioning of switch 113 is correct the welding operation continues. If the positioning of switch 113 is incorrect, the welding operation is prevented from continuing or beginning. In an exemplary embodiment of this aspect of the invention, if an erroneous position of switch 113 is detected, the control circuitry will cause switch 113 to move to a neutral position, to prevent any inadvertent welding or injury.

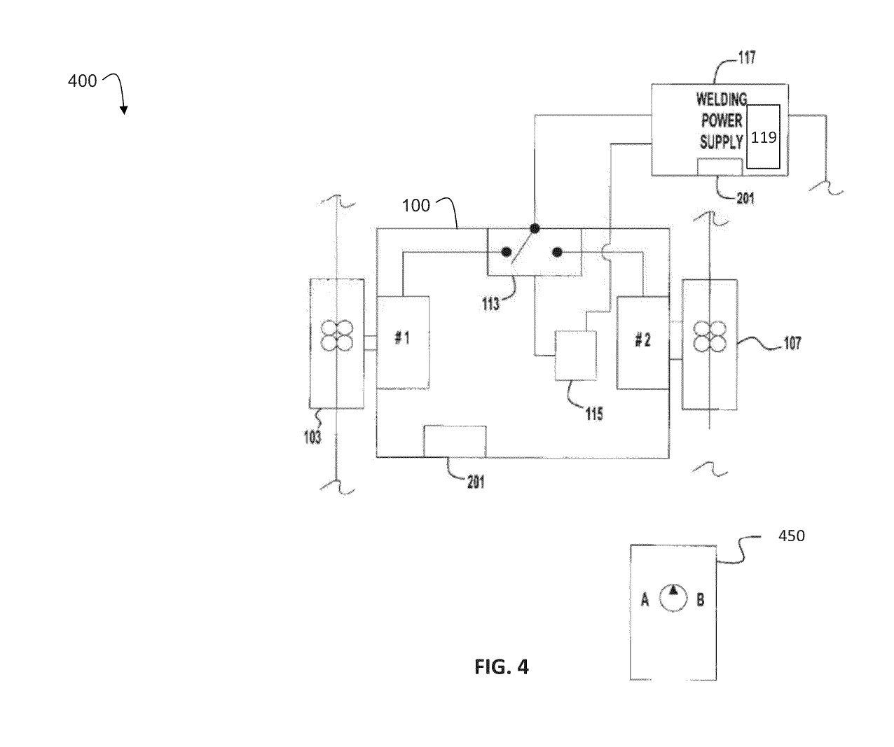

In still additional aspects shown in FIG. 4, control of switch 113 can be effected via the use of a wireless transmitter, such as a pendant device 450 which is capable of transmitting wireless signals to a wireless receiver 201 in either or both of power supply 117 or wire feeder 100 to control switch 113. Further, in yet another exemplary embodiment the power supply may also have a wireless transmitter (not shown) to communicate with wire feeder 100 and control circuitry 115 wirelessly. Because the technology of wireless communication is generally known and understood, a detailed discussion of this technology will not be included herein. In a further exemplary embodiment the pendant device 450 can be coupled to or incorporated into a welding helmet (not shown). Specifically, it is contemplated that at least some of the controls of the system can be incorporated into a welding helmet structure employing, for example, wireless communication methodologies to communicate with control circuitry 115/119 and/or the wireless receiver 201.

In each of the above discussed exemplary embodiments, the use of switch 113 prevents both wire feeding devices 103/107 and welding guns 120A/120B from being electrically “hot” at the same time during a welding operation. This is because the welding current/signal is being directed to only one wire feeding device/welding gun at any given time. Moreover, as shown below, the control of switch 113 can be effected in any number of ways, including manual and automatic switching. When using automatic switching any number of various control methodologies can be utilized as discussed above.

In a further exemplary embodiment of the present invention, switch 113 is prevented from being switched during a welding operation or when there is a minimum amount of current being transmitted from the welding power supply.

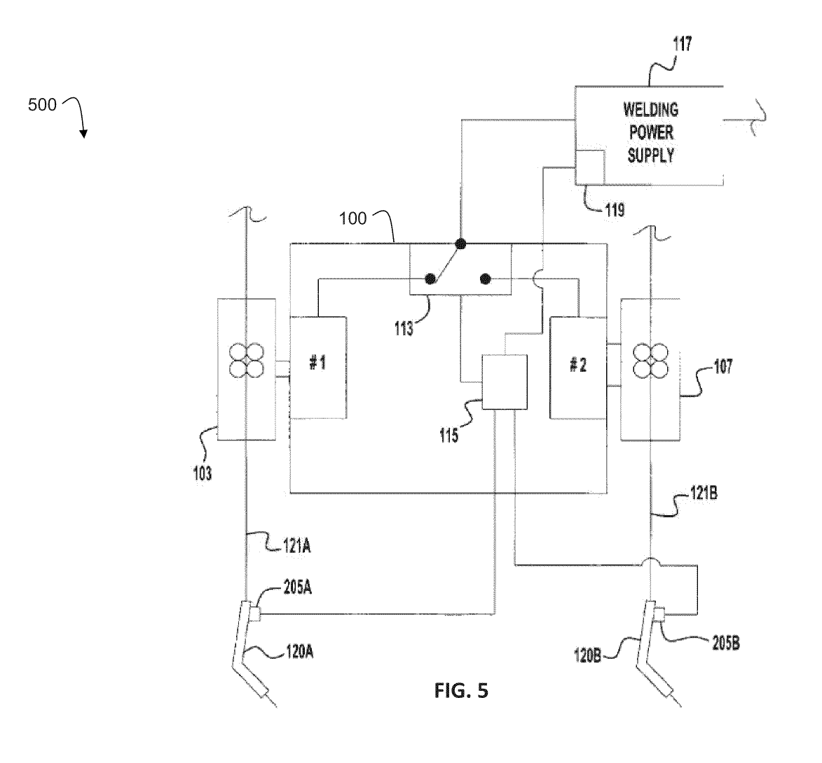

FIG. 5 depicts yet a further exemplary embodiment of the present invention. In this embodiment, each of welding guns 120A/120B contains switches 205A and 205B, respectively, which is electrically or wirelessly coupled to control circuitry 115 in wire feeder 100 and/or control circuitry 119 in the power supply 117. Switches 205A and 205B may be stand alone switches on the welding guns or may also be electrically coupled to the triggers (not shown) on the welding guns which are activated when the triggers on the guns are activated. In this embodiment, when a user either activates switch 205A or 205B, or activates the trigger on a respective gun, a signal is sent to control circuitry 115 which causes switch 113 to be positioned appropriately for the use of the appropriate welding gun. In this embodiment, control of the switch is effectively accomplished remotely at the welding gun. In practice, a user pulls a trigger on welding gun 120A (or otherwise activates switch 205A) which causes control circuitry 115 to properly position switch 113 so that it corresponds to the activated gun. In this embodiment, the user merely activates the switching/trigger on the welding guns to cause wire feeder 100 to operate appropriate wire drive device 103/107. In an alternate example of this embodiment, the activation of trigger or switch 205A/205B is acknowledged by control circuitry 119 of power supply 117. Control circuitry 119 then causes power supply 117 to provide the appropriate welding power/current associated with the activated welding gun. For example, in an embodiment of the invention, control circuitry 119 of power supply 117 contains at least two different welding programs/operations programmed for welding operations and associates each one of the programs/operations to one of respective welding guns 120A/120B. When a signal is received by control circuitry 119 from either wire feeder 100 (via control circuitry 115) or from one of respective welding guns 120A/120B control circuitry 119 causes power supply 117 to provide the appropriate welding operation. This prevents the user from having to go from the welding workpiece to power supply 117 to select a new welding operation, but by mere activation of the welding gun, a user can ensure selection of the appropriate welding operation.

For example, an embodiment of the invention is to be used for both a MIG welding operation having a first welding waveform and parameters and flux cored welding having a second welding waveform and parameters which are different from the first set of parameters. First wire drive device 103 and welding gun 120A is associated with the MIG welding operation, while second wire drive device 107 and welding gun 120B are associated with the flux-cored welding operation. When a user wishes to perform the MIG welding operation the user selects appropriate welding gun 120A and activates trigger or switch 205A. Upon activation of switch 205A, control circuitry 119 recognizes that the programmed MIG welding operation is to be performed and causes power supply 117 to deliver the appropriate MIG welding waveform through wire feeder 100 and wire drive device 103 to gun 120A. Further, as discussed with the many embodiments above, at least one of control circuitry 115 (wire feeder) and/or control circuitry 119 (power supply) ensures that switch 113 is positioned appropriately to direct the welding waveform to wire drive device 103 and welding gun 120A. This embodiment allows for easy and efficient switching from a first welding operation to a second welding operation, while at the same time protecting the user because of the use of switch 113 in wire feeder 100. Of course, as with other embodiments of the present invention, this aspect of the invention is not limited to a “dual” feeder configuration, but also includes embodiments having three or more separate wire driving devices and associated components.

It is noted that the present invention is not limited to the type or manufacture of power supply 117, but can be used with any known or used welding power supply, including but not limited to TIG, MIG, sub-arc, et cetera, type welding power supplies.

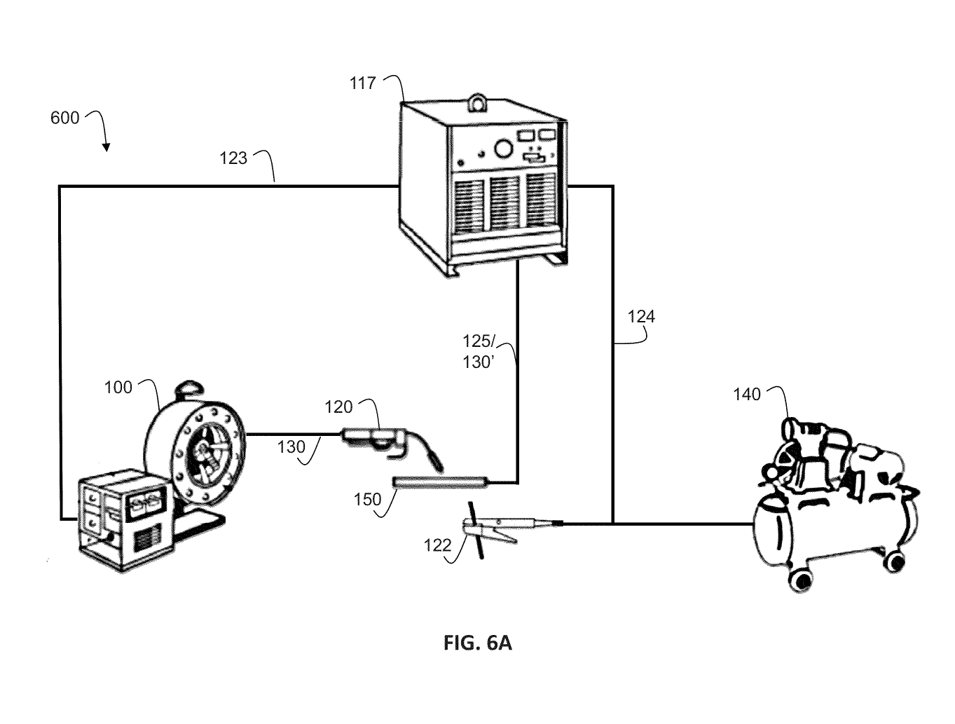

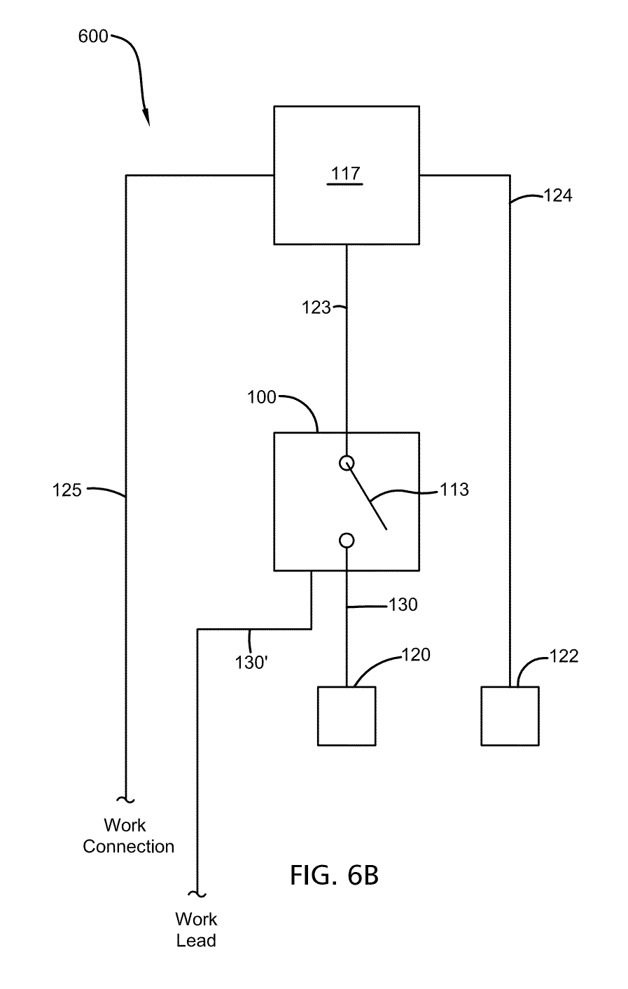

FIGS. 6A and 6B illustrate diagrammatical schematic representations of embodiments of system 600 including wire feeder system 100 and gouging torch 122. In system 600, wire feeder system 100 may include switch 113 as in FIG. 2. In this regard, wire feeder system 100 can be illustrated here and elsewhere in the simplified form shown in FIG. 6B.

System 600 shows welding power source 117 electrically coupled with wire feeder system 100, gouging torch 122, and the work piece. In system 600, wire feeder system 100 and gouging torch 122 include no common control, and thus welding current provided to one will not impact the other. This presents a problem similar to that of prior art wire feeding systems inasmuch as both gouging torch 122, welding gun 120, and other devices can simultaneously be “hot.” Thus, in addition to the need for a wire feeder that facilitates control of welding current to two or more welding tools connected to the wire feeder, there is a need for a controller that facilitates control of welding current to two or more welding tools connected to the same welding power source.

In particular, FIG. 6A shows wire feeder cable 123 providing connectivity between at least welding power source 117 and wire feeder 100, and gouging cable 124 providing connectivity between at least welding power source 117 and gouging torch 122. Welding cable 130 provides connectivity between welding gun 120 and wire feeder 100. System 600 can include additional gouging components 140 (e.g., a gas supply) connected to a respective tool (e.g., gouging torch 122) via various cables or lines, and be powered by welding power source 117 or another power supply. Wire feeder cable 123 and gouging cable 124 are separate cables from the respective tool to welding power source 117. Work connection 125 and/or work lead 130′ can provide a connection from workpiece 150 to welding power supply 117. As will be seen elsewhere (e.g., FIG. 6B), in some embodiments a work lead can be provided from a wire feeder or other device to workpiece 150 separately from a tool (e.g., welding gun, gouging torch), and in alternative embodiments a work connection is provided from the power supply and the only other electrical contact to the workpiece may be the tool.

FIG. 6B shows aspects of system 600 in block diagram form. Unlike FIG. 6A, work lead 130′ and work connection 125 are illustrated distinctly.

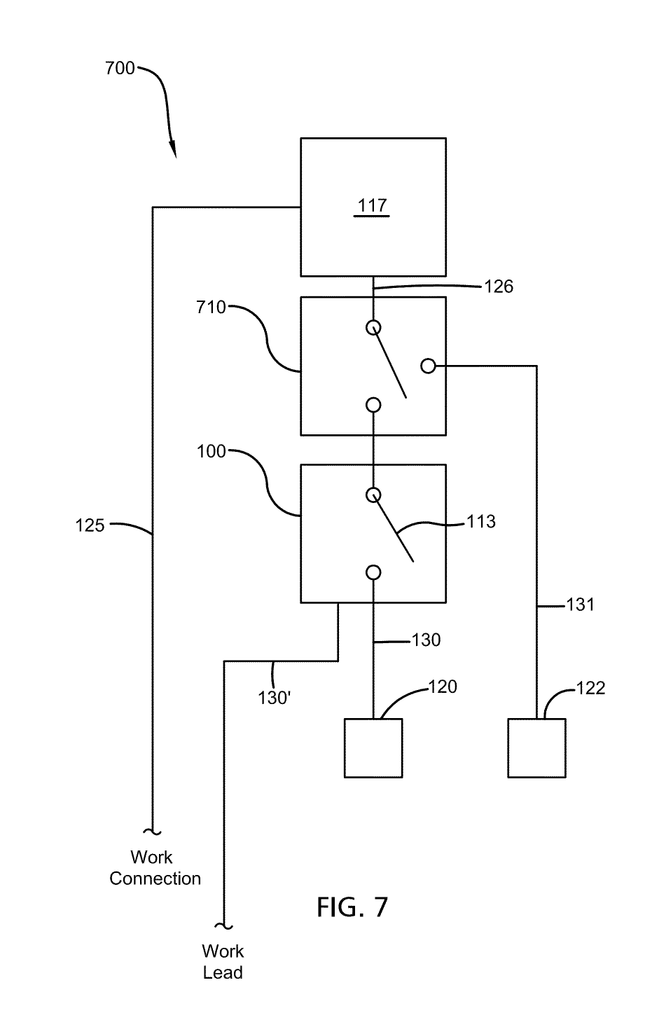

FIG. 7 illustrates a diagrammatical schematic representation of an embodiment of system 700 including a device used in conjunction with a welding suite of the present invention. FIG. 700 includes welding power source 117 including control circuitry 119. Welding power source 117 is electrically coupled with switch device 710 via integrated power cable 126 and the work piece at least via work connection 125. Electrical coupling, from welding power source 117, can be accomplished at least in part in embodiments using electrode cables.

Switch device 710 may be a switch having two or more positions that complete or interrupt a circuit including a welding tool. Switch device 710 may include physical electrical components (e.g., a rotary selector, dip switch, toggle, push button, lever, and others), logical components (e.g., information on programmable logic controllers), and combinations thereof.

In the embodiment of system 700, switch device 710 is employed between welding power source 117 and welding tools available to one or more operators. Switch 113 includes at least two positions in system 700. A first position can provide power to gouging torch 122, and a second position can provide power to wire feeder 100. However, current is not provided to both gouging torch 122 and wire feeder 100 simultaneously. In embodiments, switch device 710 can have additional positions accommodating other welding tools, or to provide power to additional non-welding tools or other powered devices. In embodiments, switch device 710 can also include one or more neutral positions, and provides no electrical current to any device at such time.

In embodiments, switch device 710 can include multiple electrical connections. For example, two or more output electrical connections of switch device 710 can accommodate two or more switches capable of toggling between different power routings for powered devices. In an embodiment, two or more switches can facilitate the use of two or more devices simultaneously. Alternatively, two or more switches can be used in concert to increase the number of connected devices but still restrict use to a single “hot” device. In other alternative or complementary embodiments, two or more switches can be used to power two or more workstations or provide multiple operators with access to the same welding power source 117.

In embodiments, multiple input and output connections in switch device 710 can also facilitate flow-through of current. For example, one or more sockets can be provided at switch device 710 for non-welding tools. The socket(s) can be electrically powered at all times, or toggled “on” or “off” using a switch separate from that directed toward welding tools. In embodiments, switch device 710 can include various power converters, inverters, or other components to modify electricity provided to accommodate particular specifications required for types of powered devices that can be plugged into sockets or otherwise electrically connected at switch device 710 (or elsewhere downstream).

Switch device 710 can be located in a variety of physical locations. In embodiments, switch device 710 can be attached to one or more welding tools (e.g., attached to wire feeder 100). In embodiments, switch device 710 or modules thereof can be installed in a welding device. Switch device 710 can also be mounted at a convenient location, kept at a work site, and so forth.

While many applications of switch device 710 suggest it should be substantially collocated with welding tools, nothing herein should be construed to prevent its installation and use at any other point of electrical communication throughout the circuit(s) of system 700 or other systems.

As shown in FIG. 7, switch device 710 can operate in conjunction with other switches. Wire feeder 100 includes switch 113 that can be used to provide or interrupt welding current to at least one welding gun 120. In embodiments, multiple welding tools can be connected to wire feeder 100, and switch 113 can be a multi-position switch that can provide current to one or more devices exclusively or in specific combinations such that the devices are powered in a way that maximizes safety (e.g., preventing more than a maximum number of welding tools or other devices to be powered simultaneously), efficiency (e.g., enabling multiple operators to simultaneously use multiple welding tools), or other purposes.

System 700 includes integrated power cable 126. Integrated power cable 126 is a single cable (e.g., one line, as distinguished from multiple cables or lines singly packaged or protected within a conduit) configured to carry power and/or signals utilized by two or more dissimilar welding processes. For example, integrated power cable 126 can connect welding power source 117 and switch device 710 such that no additional power or signal wires are connected to welding power source 117. In this way, the expense of the system can be by reducing the amount of cabling; the stability of the system can be increased and maintenance reduced as multiple cables will not be exposed to damage or disconnection; the weight is decreased for easier movement and fewer placement constraints based on less cabling weight; and flexibility can be improved due to shorter set-up time and reduced support needs.

While integrated power cable 126 is shown illustrated herein as connecting welding power source 117 and switch device 710, it is understood that integrated power cable can be routed to other portions of the system (e.g., wire feeder 100) allowing dissimilar welding processes to be performed from a different site. In some embodiments, integrated power cable 126 does not have a direct physical connection to switch device 710, but transfers power based at least in part on signals related to switch device 710. For example, welding power supply 117 can provide at least power through integrated power cable 126 to wire feeder 100, or another node such as a breaker or hub. Switch device 710 can be connected, directly or through other devices, to wire feeder 100 or the other node. Based on the settings at switch device 710, a signal can be propagated to welding power supply 117 which changes the characteristics of power provided. Both the original and changed power can be provided through integrated power cable 126, even though integrated power cable 126 does not physically contact switch device 710.

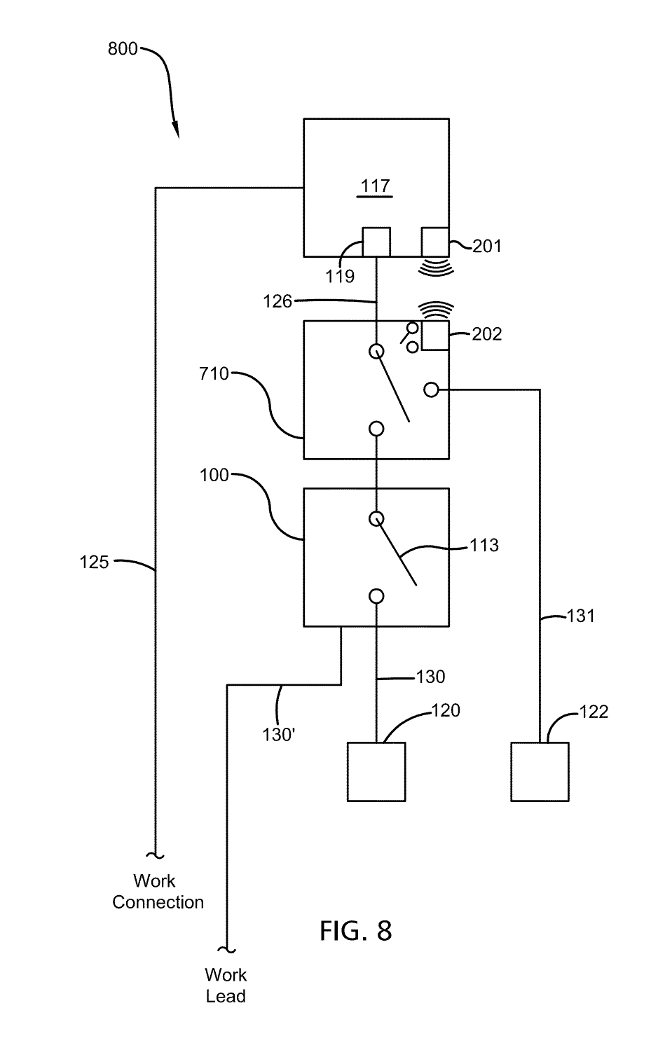

FIG. 8 illustrates a diagrammatical schematic representation of an embodiment of a system 800 including a switch device 710 used in conjunction with a welding suite of the present invention. In embodiments, different welding tools can have different requirements in terms of current, voltage, polarity, and so forth. Thus, in embodiments, merely providing the same electrical parameters to different welding tools (or other devices) may not properly function or provide optimal performance. For example, when switching between wire feeder welding gun 120 and gouging torch 122, it may be necessary to switch the polarity of the welding current from negative to positive. Thus, in addition to a switch that selectively powers devices sharing a common power source, there may be a need to adjust settings, change parameters, or apply different programs at the power source. In another embodiment, a non-welding used in conjunction with switching device 710 tool may utilize different parameters or power settings than welding tools.

Switch device 710 can include wireless transmitter 202 which can communicate to wireless receiver 201 located at or in communication with welding power source 117. Depending on the settings of switch device 710, wireless transmitter 202 can provide information to wireless receiver 201 to modify parameters of at least one portion of the electricity provided by welding power source 117. In embodiments, particular parameters can be associated with a specific switch setting. Such parameters can be permanently assigned to each switch setting, or reprogrammable depending on usage. In embodiments, electrical parameters can be automatically detected based on devices attached to switching device 710. Switch device 710 can provide for both physical (e.g., complete or interrupt circuit) and logical (e.g., provide control signals) control in this or other embodiments by being implemented as a combination of physical circuitry and logical components.

Wireless receiver 201 and wireless transmitter 202 can utilize known or proprietary standards in wireless communication. For example, wireless receiver 201 and wireless transmitter 202 can employ one or more of networks using standards such as 802.11, infrared, ultrasonic, Bluetooth™, Wireless USB, and other wireless radio and energy transmission and reception techniques.

In embodiments, additional cables or electrical connections can be provided to facilitate the supplying of multiple power parameters. For example, an additional connection (not pictured) can be provided to support different polarities. In alternative or complementary embodiments, different connections can be used to carry electricity having different parameters. For example, different electrode cables can be provided and selectively powered based on the parameters needed downstream.

Welding power source 117 can include control circuitry 119 operatively coupled to wireless receiver 201. Control circuitry 119 can modify parameters, programs, or settings at welding power source 117 to provide the requested or required power to components of system 800. In embodiments, control circuitry 119 and wireless receiver 201 can be an integrated component.

Welding power source 117 is additionally coupled to at least one device capable of routing power from welding power source 117 to dissimilar welding tools. Welding power source provides this power via integrated power cable 126, which includes a single line capable of carrying power for two or more dissimilar welding processes. While welding power source 117 may have more than one output port or line, integrated power cable 126 combines and/or encompasses the role of a line to two or more devices, reducing the number of cables. For example, power carried by integrated power cable 126 can be used to conduct welding, gouging, cutting, and/or other operations.

In embodiments, wireless receiver 201 and wireless transmitter 202 can instead be wireless transceivers capable of both sensing and receiving information at both points. In this way, additional functionality can be provided. For example, information related to welding power source 117 (e.g., loss of power, manual change to power parameters, disconnection of cable, component failure, surging or ebbing power, and others) can be forward-propagated to switch device 710. This information can be presented to an operator, trigger an alarm, cause switch device 710 to move to a neutral position, or cause other action at switch device 710, welding power source 117, or a specific powered device capable of receiving information or instructions remotely.

In an embodiment, exchange of data between wireless components 201 and 202 can be used to detect inconsistent parameters (e.g., incorrect waveform) at welding power source 117 and one or more devices downstream of welding power source 117 (e.g., gouging torch 122, welding gun 120, and other devices powered through switch device 710). If an unsafe condition, inefficient utilization, or other condition contradicting a logical rule (e.g., parameter-equipment match as determined by, for example, control circuitry 119) is expected to occur based on one or more of a welding power source parameter, a switch position or selection of switch device 710, and/or a pending or ongoing use of a welding tool, an action can be taken. The action taken can include returning a switch of switch device 710 to a neutral position, shutting off welding power source 117, changing a parameter at welding power source 117 or a welding tool, notifying a user, sounding an alarm, and so forth.

Further, while system 800 demonstrates a system employing wireless communication, nothing herein should be interpreted to prohibit the use of wired communication systems in providing feedback and control between components of system 800 or other systems herein.

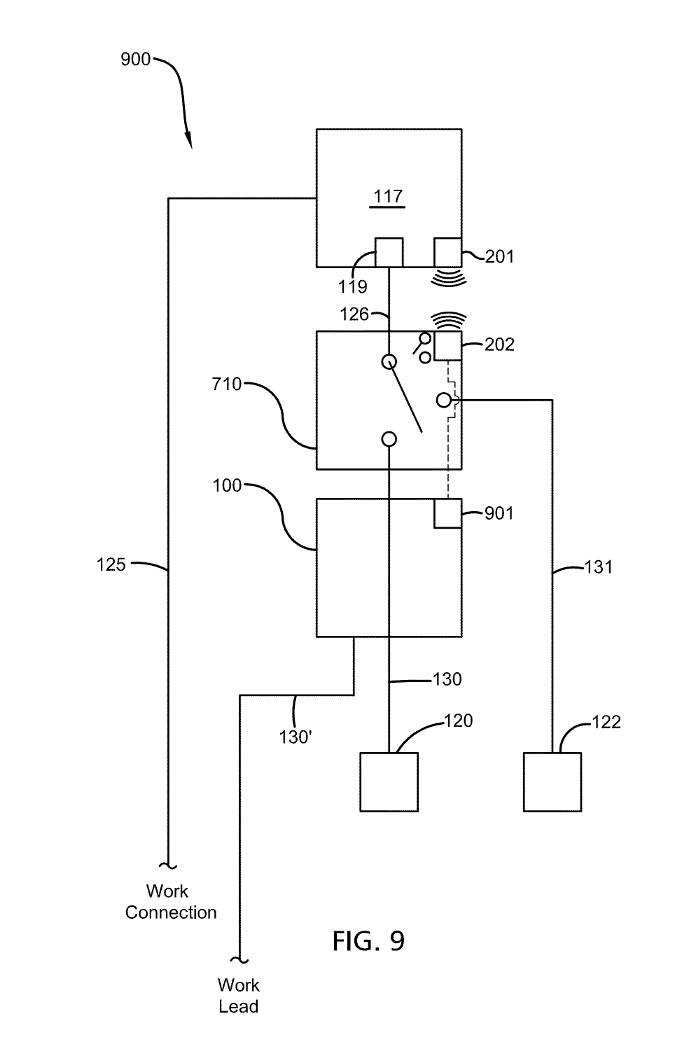

FIG. 9 illustrates a diagrammatical schematic representation of an embodiment of system 900 including a switch device 710 used in conjunction with a welding suite of the present invention. Switch device 710 can receive a trigger signal from a welding tool or associated system such as wire feeder 100. For example, a trigger signal from welding gun 120 and/or gouging torch 122 can be used as an input or parameter to modify the setting of switch device 710 or pass a signal upstream to welding power source 117. In an example embodiment, a first signal from a welding tool (e.g., gouging torch 122, welding gun 120) can be treated as a request to energize the welding tool. Rather than immediately make the welding tool “hot,” a second action (e.g., second trigger to the welding tool) can be used to make the tool “hot” after the first signal is processed and the other components of system 900 appropriately set. In alternative embodiments, a first signal can both serve as a request and actually make the welding tool “hot.” Other control configurations will be appreciated by those of ordinary skill in the art upon review of the disclosures herein.

System 900 can include trigger module 901 to provide the trigger signal. Trigger module 901 can be an organic component of a welding device (including wire feeder 100), an added module that interacts or monitors an organic component of a welding device, or a separate component integrated with one or more portions of system 900. For example, in embodiments, trigger module 901 can be the trigger or energizing control for various components of system 900 including wire feeder 100. In embodiments, there can be a plurality of trigger modules 901 operatively coupled to or with other components of system 900 such as welding gun 120 or gouging torch 122. In further embodiments, one or more of a plurality of trigger modules 901 can be operatively coupled to or with a non-welding tool (not pictured) that receives power from welding power source 117.

In embodiments, a variety of actions can function as a trigger signal. For example, pulling a trigger, toggling an actuator, extending a cable, and other operator actions can be utilized as signals. In embodiments, automated signals based on position or distance (e.g., employing radio frequency identifiers, magnets, inductive technologies, location triangulation, and others) can be used as conditions for transmitting a signal. For example, the proximity of a welding tool to a welding helmet, work piece, storage rack, other welding tool, and other items in the work space or facility can be used to energize or de-energize the welding tool. In embodiments, such proximity techniques can be used in conjunction with other trigger signal techniques to provide an additional layer of safety or control. For example, proximity from a wire feeder and proximity to a work piece may not by themselves trigger a signal requesting to energize a torch, but relevant proximities may be a condition for such signal to be transmitted or processed.

In embodiments, one or more welding tools can include at least a wireless transmitter for providing a trigger signal. In alternative or complementary embodiments, existing wires (e.g., electrode cables) or other wired solutions can be employed for the transmission of signals from (and, in embodiments, reception of signals to) welding tools.

Where welding tools can be adjusted (e.g., changing tool settings at the tool or remotely), tool settings can comprise at least a portion of feedback (e.g., a trigger signal) between a welding tool and at least switching device 710. In embodiments (not illustrated) one or more wireless communication components or built-in switches can be installed in a plurality of welding tools to facilitate techniques herein. For example, by facilitating communication of state information regarding welding tools to a central controller or between the welding tools, a logical switch can be enabled such that the energizing of one tool de-energizes all others. Such architectures may obviate the need for a hard-wired switch upstream of the welding tools, as each tool can include internal physical or logical switches that are dependent upon the state of other welding tools or equipment. Welding tool can include one or more control circuits to facilitate processing of information from the switch implemented as a logic component.

In embodiments, a time buffer or condition can be imposed at switch device 710 to permit communication between different components of system 900. For example, if a trigger signal from welding gun 120 is intended to switch a welding current from gouging torch 122 using switch device 710, switch device 710 can await data from other components or delay switching to welding gun 120 in order to confirm that the parameters at welding power source 117 are appropriate or will be changed before energizing welding gun 120.

As described above, switch device 710 can be installed in any appropriate location. By utilizing remote communication between switch device and one or more of welding power source 117 and/or welding tools downstream, switch device 710 can be placed in a position where it is otherwise inaccessible to an operator. In alternative embodiments, switch device 710 can be located with an operator, or can even be worn by an operator.

In embodiments, non-welding tools or other powered devices can be integrated into the techniques described herein. For example, where switch device 710 includes or is upstream of sockets for other tools or powered devices (e.g., grinders, drills, saws, and others), switch device 710 can similarly enforce an architecture where only one tool is energized at any time. In alternative embodiments, some power routes can pass-through to allow continuous energizing of some routes while enforcing selective energizing of others.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A system for controlling an electrical current to a first welding tool and a second welding tool, comprising:
a switch device operatively coupled to a welding power supply and the first welding tool and the second welding tool that controls the electrical current from the welding power supply to the at least one welding tool; and
a control circuit communicatively coupled with the switch device which automatically controls the switching of the switch device between at least a first setting and a second setting,
wherein when the switch device is in the first setting a first current is directed to the first welding tool such that the second welding tool electrically isolated from the first current and when the switch device is in the second setting a second current is directed to the second welding tool such that the first welding tool is electrically isolated from the second current, and
wherein the switch device is operatively coupled to the welding power supply using at least an integrated power cable.

2. The system of claim 1, wherein the control circuit is housed within the switch device.

3. The system of claim 1, wherein the switch device has at least a third setting which prevents either one of the first or second current from being directed to either of the first or second welding tools.

4. The system of claim 1, wherein the first welding tool is connected to the system through a wire feeder connected to the switch device, and the second welding tool is connected directly to the switch device.

5. The system of claim 1, further comprising a control panel through which the switch device can be controlled by a user.

6. The system of claim 1, wherein the switch device is automatically switched between the first setting and the second setting based on a signal from the welding power supply.

7. The system of claim 6, wherein the signal is based on a tool parameter.

8. The system of claim 6, wherein the switch device and the welding power supply exchange the signal via wireless communication.

9. The system of claim 1, further comprising a remote control component of the switch device which remotely causes execution of an instruction at the welding power supply.

10. The system of claim 1, further comprising a trigger module within one of the first welding tool and the second welding tool that transmits a trigger signal to the switch device.

11. The system of claim 10, further comprising a remote control component of the switch device which transmits an instruction to the welding power supply based at least in part on the trigger signal.

12. The system of claim 1, wherein the switching device is additionally coupled to a non-welding tool.

13. A power routing system, comprising:
a first welding tool powered according to a first parameter set through a wire feeder, the wire feeder is coupled with a welding power supply to perform a first welding operation;
a second welding tool powered according to a second parameter set, the second welding tool is coupled with the welding power supply to perform a second welding operation;
a switch device configured to complete a circuit between at least the welding power supply and the first and second welding tools;
a control circuitry of the switch device that controls switching between at least a first setting and a second setting; and
an integrated power cable that provides power according to the first parameter set and the second parameter set,
wherein when the switch device is in the first setting a first current is directed to the first welding tool such that the second welding tool is electrically isolated from the first current, and when the switch device is in the second setting a second current is directed to the second welding tool such that the first welding tool is electrically isolated from the second current, and wherein the first welding operation is dissimilar from the second welding operation.

14. The power routing system of claim 13, wherein the switch device has at least a neutral setting which prevents either one of the first or second current from being directed to either of the first or second welding tools.

15. The power routing system of claim 13, wherein the first welding tool is a welding gun, and wherein the second welding tool is a gouging torch.

16. The power routing system of claim 13, further comprising a non-welding tool powered according to a non-welding parameter set, wherein the switch device has at least one non-welding setting which provides a third current to the non-welding tool, wherein the at least one non-welding setting prevents either one of the first or second current from being directed to either of the first or second welding tools.

17. The power routing system of claim 13, wherein the switch device is automatically switched between the first setting and the second setting based on a signal from the welding power supply.

18. The power routing system of claim 13, further comprising at least one trigger module operatively coupled with at least one of the first welding tool and the second welding tool that provides a trigger signal to at least the switch device.

19. The power routing system of claim 13, further comprising:
a first tool control circuit of the first welding tool configured to receive a signal from the switching device to interrupt the first current; and
a second tool control circuit of the second welding tool configured to receive a signal from the switching device to interrupt the second current;
wherein the switch device is implemented as a logic component.

20. A method of routing current to a plurality of welding tools, comprising:
providing an integrated power cable for supplying a current;
providing a switch device for completing a circuit between a welding power supply and at least one of a first welding tool that performs a first welding operation adding metal to a workpiece and a second welding tool that performs a dissimilar second welding operation removing metal from the workpiece;
receiving a signal related to at least one of the first welding operation and the dissimilar second welding operation;
providing the current to at least one of the first welding tool and the second welding tool based on a setting of the switch device; and
modifying a parameter of the welding power supply based on the setting of the switch device, wherein the dissimilar second welding operation utilizes a polarity from the welding power supply substantially opposite of that of the first welding operation.
